(19) United States
(12) Patent Application Publication
(10) Pub. No.: US 2007/0266682 A1
(43) Pub. Date: Nov. 22, 2007

(54) AIR INTAKE ASSISTING DEVICE FOR AUTOMOBILE ENGINE

(76) Inventor: Shih-Chi Lo, Hsin Chu Hsien (TW)

Correspondence Address: LEONG C LEI, PMB # 1008, 1867 YGNACIO VALLEY ROAD, WALNUT CREEK, CA, 94598, US

(21) Appl. No.: 11/383,499

(22) Filed: May 16, 2006

(51) Int. Cl. B01D 46/00

(52) U.S. Cl. 55/385.3

(57) ABSTRACT

An air intake assisting device for automobile engine is disclosed, including a body comprised of a receiving cylinder and upper and lower caps. The receiving cylinder receives and fixes a partition plate therein. The partition plate defines an air passage, and a pressure-balance aperture. The upper cap forms a plurality of air inlet openings. The lower cap forms a coupling bore in an upper portion thereof and a tubular fitting section on a lower portion and in communication with the coupling bore. A spring, a steel sphere, and a board defining a circular hole are received in the coupling bore. A filtering member is disposed in the receiving cylinder and located above the partition plate. The fitting section of the lower cap is connected by a hose to an automobile engine air-intake manifold and an air tube of an assisting brake pump whereby, upon starting the engine, external air is drawn through the filtering member to the engine air-intake manifold to mix with fuel injected into the engine for enhancing fuel combustion.

### BACKGROUND OF THE INVENTION

(a) Technical Field of the Invention

The present invention relates to an air intake assisting device for automobile engine, and in particular to an air intake assisting device that constantly supplies sufficient air to an operating automobile engine to effect complete fuel combustion without modification of the original structure of the automobile.

(b) Description of the Prior Art

It is known that automobile power is drawn from thermal energy obtained with the combustion of a fuel mixture with air. The power generated by an automobile engine gets larger if the amount of fuel-air mixture drawn into the engine is increased and/or compression ratio of the engine is larger. On the other hand, insufficient air supply to the engine often results in incomplete combustion of fuel, and consequently leading to carbon deposition, increased fuel consumption, lowering of output power, and air pollution.

The structure of the currently available automobiles comprises an engine, which has a main air intake tube connected to an air filter, and an air-intake manifold connected to an assisting brake pump. Air that is required for fuel combustion is drawn into the engine through the air filter. However, after a long term use of the automobile, efficiency of air intake lowers due to aging of parts, incorrect operation, or dust stuck on a filtering screen of the air filter, leading to insufficient air supply to the engine. Such an insufficient air supply cannot be immediately observed by the automobile drivers or users and is often later revealed by the lowering of output power and/or abnormal fuel consumption after a significant air pollution has already made to the environment and a great deal of fuel has been wasted.

One effective way to handle the problem is to frequently clean the filtering screen of the air filter. This, however, only alleviates the problem, not completely solve the problem.

### SUMMARY OF THE INVENTION

The primary purpose of the present invention is to provide an air intake assisting device for automobile engine, which, without modification to the original structure of the automobile, can constantly provide sufficient air supply to an operating automobile engine in a simple installation to effect complete combustion of fuel.

The air intake assisting device of the present invention comprises a body comprised of a receiving cylinder and upper and lower caps. The receiving cylinder receives and fixes a partition plate therein. The partition plate defines an air passage at a center thereof and a pressure-balance aperture. The upper cap forms a plurality of air inlet openings. The lower cap forms a coupling bore in an upper portion thereof and a tubular fitting section on a lower portion and in communication with the coupling bore. A board defining a circular hole, a spring, and a steel sphere are received in the coupling bore. After a filtering member is disposed in the receiving cylinder and located above the partition plate, the upper and lower caps are secured to the upper and lower ends of the receiving cylinder, and the fitting section of the lower cap is connected to an air-intake manifold of the automobile engine and an air tube of an assisting brake pump whereby, upon starting the engine, external air is drawn through the filtering member to the air-intake manifold to mix with fuel injected into the engine for enhancing fuel combustion.

In the air intake assisting device described above, an arc recess is defined in an underside of the partition plate, corresponding to and in communication with the air passage, for partially receiving the steel sphere, whereby when the engine is not in operation, the steel sphere is located inside the recess to block the air passage for regulation of air into the engine, and when the engine is in operation, the suction inside the air intake manifold causes the steel sphere to separate from the air passage and external air is then allowed to flow toward the engine.

The receiving cylinder the above described air intake assisting device can be directly coupled to an air filter that is originally installed in the automobile, or an additional air filter can be coupled to the receiving cylinder of the air intake assisting device.

The foregoing object and summary provide only a brief introduction to the present invention. To fully appreciate these and other objects of the present invention as well as the invention itself, all of which will become apparent to those skilled in the art, the following detailed description of the invention and the claims should be read in conjunction with the accompanying drawings. Throughout the specification and drawings identical reference numerals refer to identical or similar parts.

Many other advantages and features of the present invention will become manifest to those versed in the art upon making reference to the detailed description and the accompanying sheets of drawings in which a preferred structural embodiment incorporating the principles of the present invention is shown by way of illustrative example.

### BRIEF DESCRIPTION OF THE DRAWINGS

The present invention will be apparent to those skilled in the art by reading the following description of preferred embodiments of the invention, with reference to the attached drawings, in which:

FIG. 1 is an exploded view of an air intake assisting device constructed in accordance with the present invention;

FIG. 2 is a cross-sectional view of the air intake assisting device of the present invention in an assembled condition;

FIG. 3 is a perspective view of the air intake assisting device of the present invention with an upper cap detached for installation of a filtering member;

FIG. 4 is a perspective view showing the installation of the air intake assisting device of the present invention in an automobile, of which only a portion is shown in the drawing;

FIG. 5 is a cross-sectional view of the air intake assisting device of the present invention for demonstrating the operation of the air intake assisting device;

FIG. 6 is a cross-sectional view of an air intake assisting device constructed in accordance with another embodiment of the present invention;

FIG. 7 is a cross-sectional view of an air intake assisting device constructed in accordance with a further embodiment of the present invention; and

FIG. 8 is a cross-sectional view showing a modification of the air intake assisting device of the present invention containing an integrally formed board inside a lower cap of the device.

### DETAILED DESCRIPTION OF THE PREFERRED EMBODIMENTS

The following descriptions are of exemplary embodiments only, and are not intended to limit the scope, applicability or configuration of the invention in any way. Rather, the following description provides a convenient illustration for implementing exemplary embodiments of the invention. Various changes to the described embodiments may be made in the function and arrangement of the elements described without departing from the scope of the invention as set forth in the appended claims.

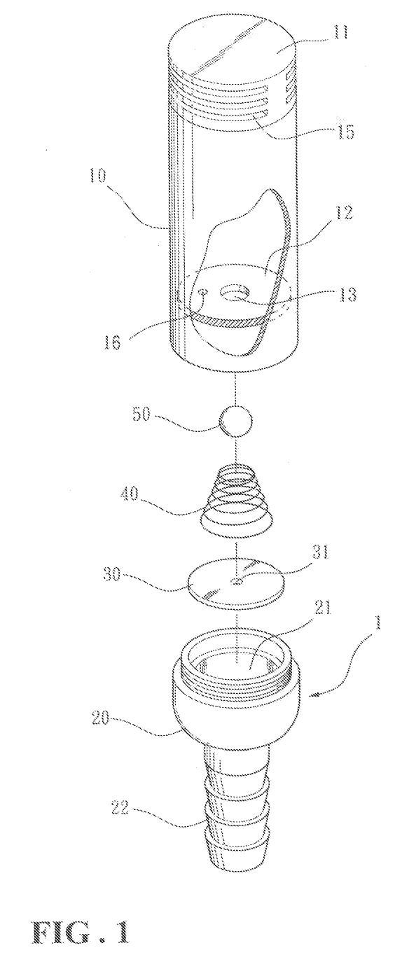

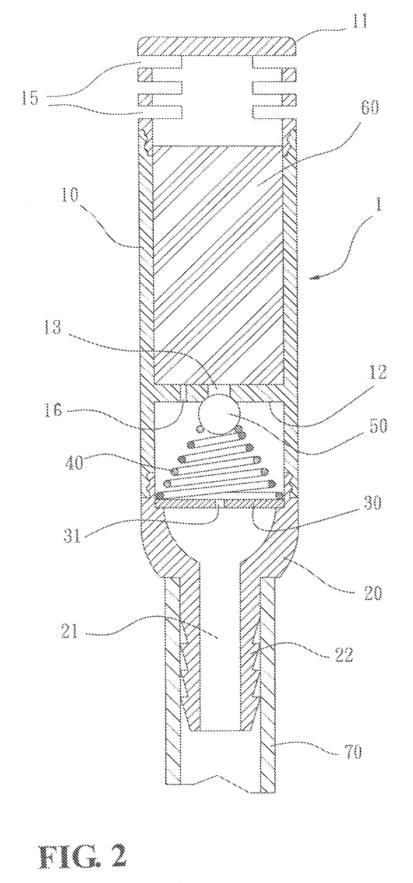

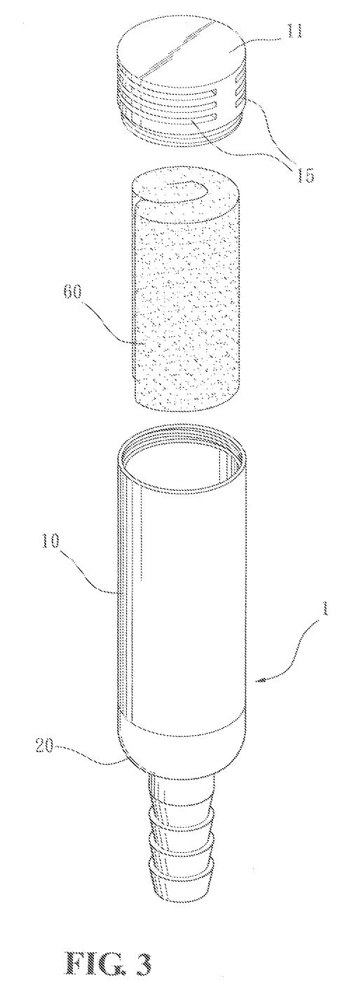

With reference to the drawings and in particular to FIGS. 1-3, and 5, an air intake assisting device for automobile engine constructed in accordance with the present invention comprises a receiving cylinder 10 defining an internal chamber having upper and lower open ends, an upper cap 11, and a lower cap 20, which all together constitute a body of the device. A partition plate 12 is received and fixed inside the internal chamber of the receiving cylinder 10 and forms a central hole 13 serving as an air passage. On the underside of the partition plate 12, an arc recess 14 is formed, corresponding to and communicating the air passage 13. An air aperture 16 is formed in the partition plate 16 on one side of the air passage 13 for pressure balance purposes.

The upper cap 11 forms a plurality of axial air inlet openings 15. The lower cap 20 defines a coupling bore 21 on an upper portion thereof and a downward-extending serrated fitting section 22 on a lower portion thereof. The fitting section 22 is tubular and is in fluid communication with the coupling bore 21. A board 30 in which a central circular hole 31 is formed is received and retained in the coupling bore 21 to support a conic coiled spring 40. A steel sphere 50 is supported on a top free end of the spring 40.

With the combination of the above described components, a filtering member 60 is fit into the receiving cylinder 10 and located above the partition plate 12 and then the upper and lower caps 11, 20 are secured to the upper and lower ends of the receiving cylinder 10 to form an air intake assisting device 1. The fitting section 22 is fit into a hose 70, which is in turn connected to an engine air intake manifold and an air tube of an assisting brake pump. When the engine is stared, external air is drawn, through the air inlet openings 15 of the upper cap 11, the air passage 13 of the partition plate 12, and the fitting section 22, into the engine air intake manifold for mixing with fuel injected into the engine to completely effect enhancement of combustion of fuel and eliminating lowering of output power, suppressing air pollution, and reducing fuel consumption. Automobile engine of different volumes can embody the present invention by simply varying the diameter of the circular hole 31 of the board 30.

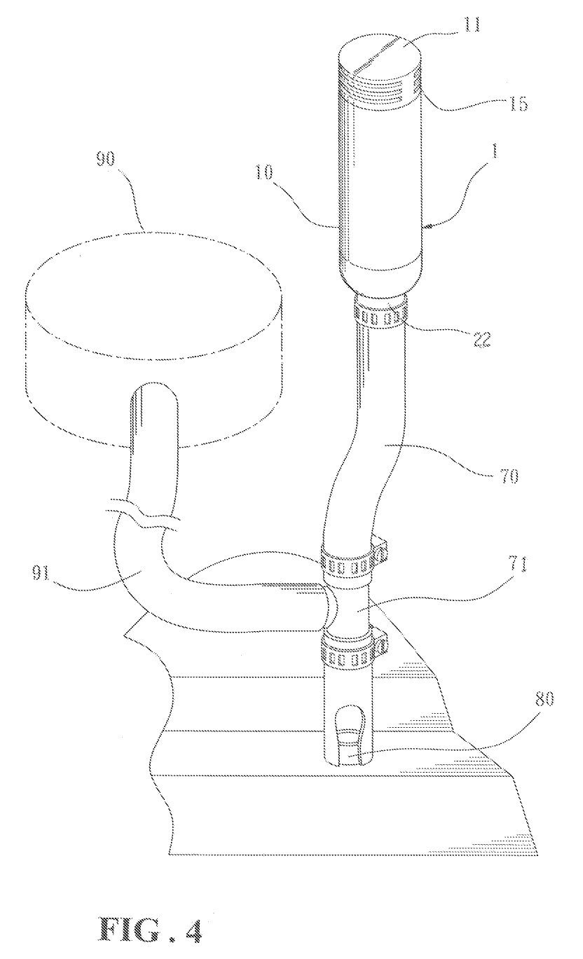

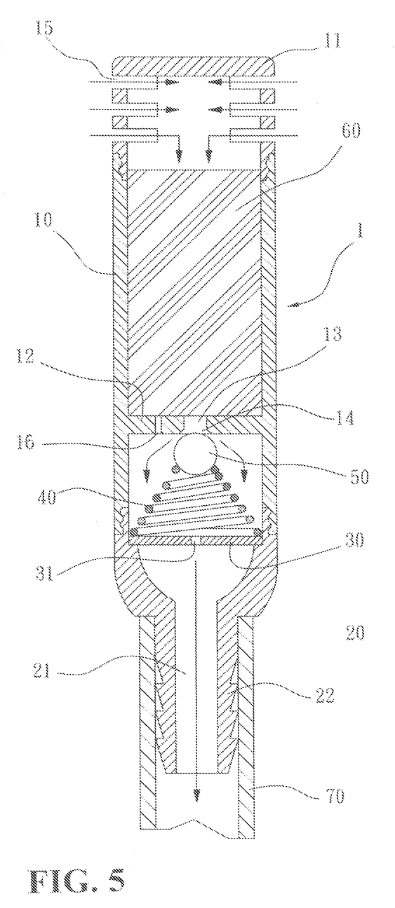

Also referring to FIGS. 4 and 5, to use the present invention, the hose 70 is fit over the fitting section 22 of the air intake assisting device 1. A three-way coupling fitting 71 is arranged in the middle of the hose 70 with a first end connected to the hose 70, a second end connected to the engine air-intake manifold 80, and a third end connected to an air tube 91 of an assisting brake pump 90 to supply external air that flows through the air passage 13 to the engine air-intake manifold 80 for mixing with fuel to assist combustion of the fuel. The air aperture 16 located by the air passage 13 serves to balance air pressure in order to maintain a predetermined distance between the steel sphere 50 and the air passage 13 when the steel sphere 50 is in a condition separated from the air passage 13 (namely the distance between the steel sphere 50 and air passage 13 can be maintained substantially constant by the pressure balance effected by the air aperture 16 during both normal operation and idle speed condition of the automobile) in order to maintain stable operation of the engine.

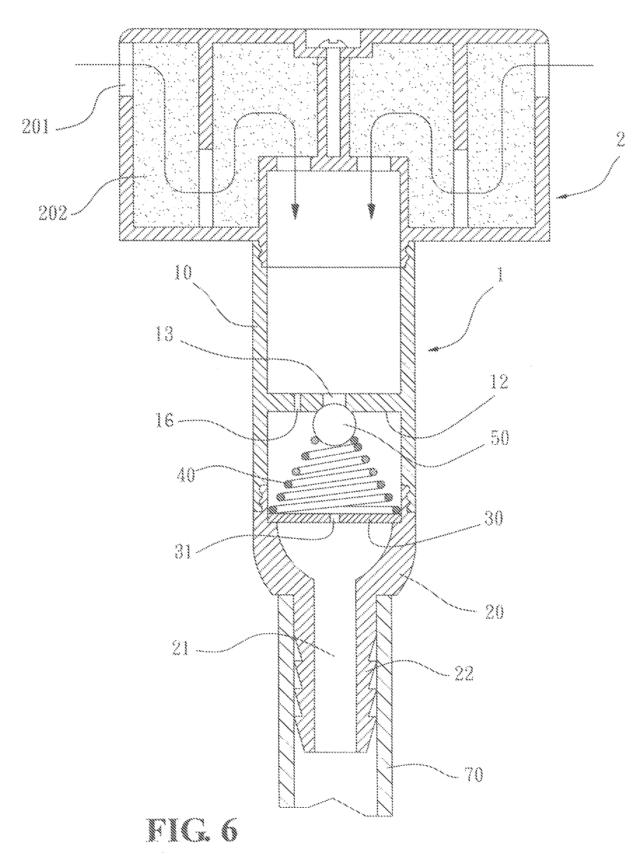

With reference to FIG. 6, the receiving cylinder 10 is selectively connected to an air filter 2. An air inlet opening 201 is formed in the air filter 2 and a filtering member 202 is received and retained in the air filter 2. This arrangement is still effective in supplying air to assist fuel combustion.

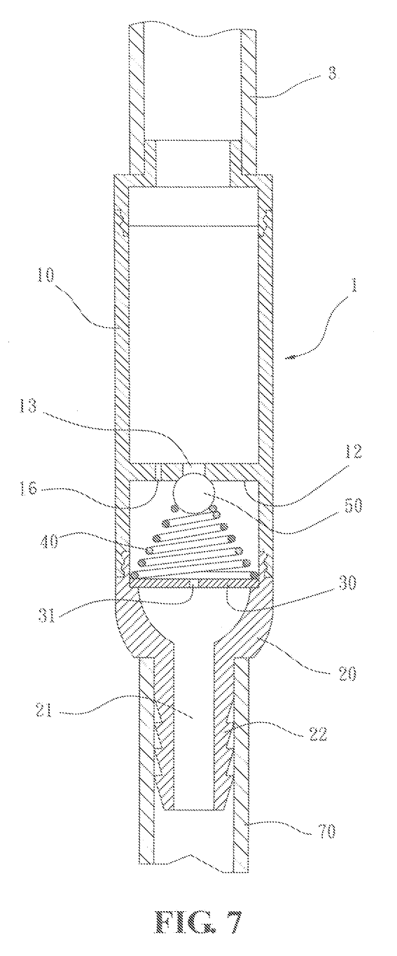

Alternatively, as shown in FIG. 7, a conduit 3 is selectively connect the receiving cylinder 10 to an air filter (not shown) that is originally equipped in the automobile to effect supply of air to assist combustion of fuel.

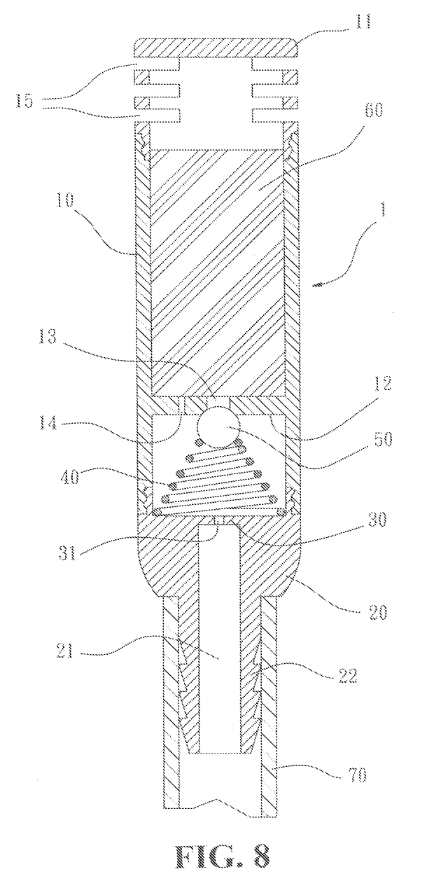

A different embodiment of the air intake assisting in accordance with the present invention is shown in FIG. 8, in which the board 30 is integrally formed inside the lower cap 20 to simplify the installation thereof.

The air intake assisting device in accordance with the present invention that itself contains a filtering member can be connected to an engine air-intake manifold and an assisting brake pump to sufficiently supply air for mixing with fuel to enhance fuel combustion and achieving elimination of power lowering, suppression of air pollution, and reduction of fuel consumption.

Although the present invention has been described with reference to what is believed to be the preferred embodiments of the present invention, it is apparent to those skilled in the art that a variety of modifications and changes may be made without departing from the scope of the present invention which is intended to be defined by the appended claims

It will be understood that each of the elements described above, or two or more together may also find a useful application in other types of methods differing from the type described above.

While certain novel features of this invention have been shown and described and are pointed out in the annexed claim, it is not intended to be limited to the details above, since it will be understood that various omissions, modification, substitutions and changes in the forms and details of the device illustrated and in its operation can be made by those skilled in the art without departing in any way from the spirit of the present invention.

I claim:

1. An air intake assisting device for automobile engine, comprising:
a receiving cylinder defining an internal chamber inside which a partition plate is received and fixed, the partition plate defining an air passage, an arc recess being defined in an underside of the partition plate and corresponding to and in communication with the air passage, a pressure-balance aperture being defined in the partition plate on one side of the air passage, a filtering member being received in the receiving cylinder and located above the partition plate;
an upper cap secured to an upper end of the receiving cylinder and defining a plurality of air inlet openings;
a lower cap secured to a lower end of the receiving cylinder and forming a coupling bore in an upper portion thereof for receiving and retaining a board that defines a central circular hole, a conic spring being positioned on the board and a sphere resting on an upper free end of the spring, the lower cap also forming a downward-extending fitting section on a lower portion thereof, adapted to connect to an automobile engine air-intake manifold and an air tube of an assisting brake pump.

2. The air intake assisting device as claimed in claim 1, wherein circular hole of the board inside the coupling bore of the lower cap is selectively of different diameter to suit for automobile engine of different volumes.

3. An air intake assisting device for automobile engine, comprising:
a receiving cylinder defining an internal chamber inside which a partition plate is received and fixed, the partition plate defining an air passage, an arc recess being defined in an underside of the partition plate and corresponding to and in communication with the air passage, a pressure-balance aperture being defined in the partition plate on one side of the air passage;
an air filter connected to an upper end of the receiving cylinder and defining an air inlet opening and containing therein a filtering member;
a lower cap secured to a lower end of the receiving cylinder and forming a coupling bore in an upper portion thereof for receiving and retaining a board that defines a central circular hole, a conic spring being positioned on the board and a sphere resting on an upper free end of the spring, the lower cap also forming a downward-extending fitting section on a lower portion thereof, adapted to connect to an automobile engine air-intake manifold and an air tube of an assisting brake pump.
